(19) United States
(12) Patent Application Publication
(10) Pub. No.: US 2012/0127870 A1
(43) Pub. Date: May 24, 2012

(54) Method and Apparatus for Enabling an Enhanced Frequency Domain Equalizer

(76) Inventors: Wanlun Zhao, San Diego, CA (US); Peter John Black, San Diego, CA (US); Jinghu Chen, San Diego, CA (US)

(21) Appl. No.: 12/952,746

(22) Filed: Nov. 23, 2010

(51) Int. Cl. H04W 24/00

(52) U.S. Cl. 370/252

(57) ABSTRACT

A method and apparatus for enabling an enhanced FDE in a TD-SCDMA system is provided. The method may comprise receiving one or more signals from one or more cells over one or more channels where each channel is described using a channel vector and a spreading vector, and where each signal includes one or more data blocks each including a number of symbols, converting the one or more received signals from a time domain into a frequency domain using a block FFT, inverting a covariance matrix, wherein the covariance matrix is derived from a linear convolution of the one or more channel vectors and the one or more spreading vectors, and determining one or more MMSE signals by manipulating the frequency domain one or more received signals by applying the inverted equivalent channel matrix.

### BACKGROUND

1. Field

Aspects of the present disclosure relate generally to wireless communication systems, and more particularly, for enabling a near optimal frequency domain equalizer (FDE) in a system, such as a time division synchronous code division multiple access (TD-SCDMA).

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UTMS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and TD-SCDMA. For example, China is pursuing TD-SCDMA as the underlying air interface in the UTRAN architecture with its existing GSM infrastructure as the core network. The UMTS also supports enhanced 3G data communications protocols, such as High Speed Downlink Packet Data (HSDPA), which provides higher data transfer speeds and capacity to associated UMTS networks.

As the demand for mobile broadband access continues to increase, research and development continue to advance the UMTS technologies not only to meet the growing demand for mobile broadband access, but to advance and enhance the user experience with mobile communications.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In accordance with one or more aspects and corresponding disclosure thereof, various aspects are described in connection enabling a near optimal FDE in a TD-SCDMA system. The method can comprise receiving one or more signals from one or more cells over one or more channels where each channel is described using a channel vector and a spreading vector, and where each signal includes one or more data blocks each including a number of symbols, converting the one or more received signals from a time domain into a frequency domain using a block fast Fourier transform (FFT), inverting a covariance matrix, wherein the covariance matrix is derived from a linear convolution of the one or more channel vectors and the one or more spreading vectors, and determining one or more minimum mean square error (MMSE) signals by manipulating the frequency domain one or more received signals by applying the inverted equivalent channel matrix.

Yet another aspect relates to an apparatus. The apparatus can include means for receiving one or more signals from one or more cells over one or more channels where each channel is described using a channel vector and a spreading vector, and where each signal includes one or more data blocks each including a number of symbols, means for converting the one or more received signals from a time domain into a frequency domain using a block FFT, means for inverting a covariance matrix, wherein the covariance matrix is derived from a linear convolution of the one or more channel vectors and the one or more spreading vectors, and means for determining one or more MMSE signals by manipulating the frequency domain one or more received signals by applying the inverted equivalent channel matrix.

Still another aspect relates to a computer program product comprising a computer-readable medium. The computer-readable medium can include code for receiving one or more signals from one or more cells over one or more channels where each channel is described using a channel vector and a spreading vector, and where each signal includes one or more data blocks each including a number of symbols, converting the one or more received signals from a time domain into a frequency domain using a block fast FFT, inverting a covariance matrix, wherein the covariance matrix is derived from a linear convolution of the one or more channel vectors and the one or more spreading vectors, and determining one or more MMSE signals by manipulating the frequency domain one or more received signals by applying the inverted equivalent channel matrix.

Another aspect relates to an apparatus for wireless communications. The apparatus can include a receiver configured to receive one or more signals from one or more cells over one or more channels where each channel is described using a channel vector and a spreading vector, and where each signal includes one or more data blocks each including a number of symbols. The apparatus may also include at least one processor configured to convert the one or more received signals from a time domain into a frequency domain using a block FFT, invert a covariance matrix, wherein the covariance matrix is derived from a linear convolution of the one or more channel vectors and the one or more spreading vectors, and determine one or more minimum mean square error (MMSE) signals by manipulating the frequency domain one or more received signals by applying the inverted equivalent channel matrix.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a Node B in communication with a user equipment (UE) in a telecommunications system.

FIG. 4 is a functional block diagram conceptually illustrating example blocks executed to implement the functional characteristics of one aspect of the present disclosure.

FIG. 5 is a diagram conceptually illustrating an exemplary TD-SCDMA based system with multiple UEs communicating with a node B as time progresses in an aspect of the present disclosure.

FIG. 6 is a diagram conceptually illustrating an exemplary wireless communications system in an aspect of the present disclosure.

FIG. 7 is a block diagram of an exemplary wireless communications device configured to enable near optimal FDE according to an aspect.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

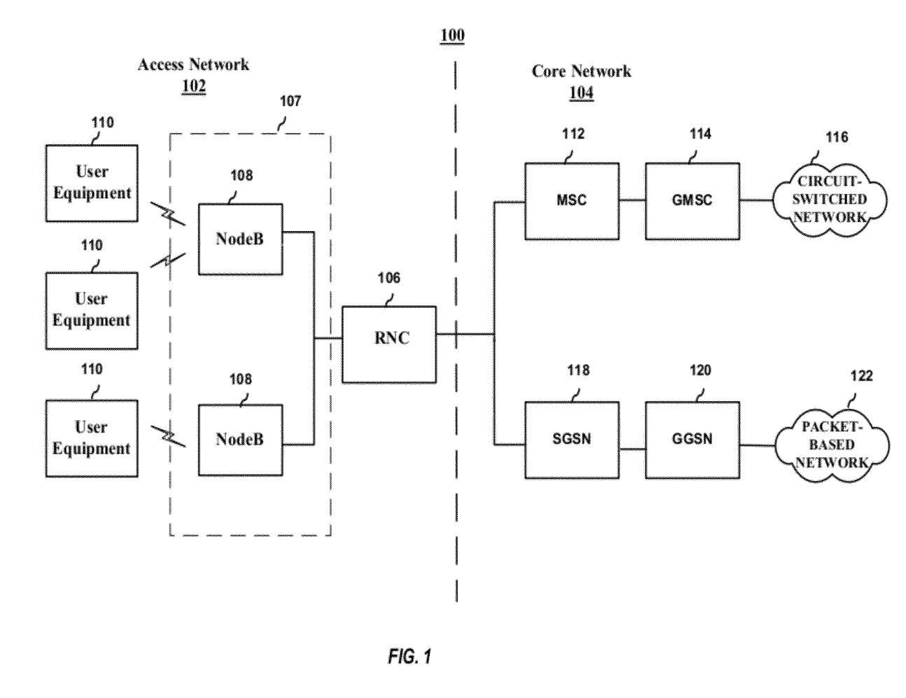

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (radio access network) RAN 102 (e.g., UTRAN) that provides various wireless services including telephony, video, data, messaging, broadcasts, and/or other services. The RAN 102 may be divided into a number of Radio Network Subsystems (RNSs) such as an RNS 107, each controlled by a Radio Network Controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two Node Bs 108 are shown; however, the RNS 107 may include any number of wireless Node Bs. The Node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as UE in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the Node Bs 108. The downlink (DL), also called the forward link, refers to the communication link from a Node B to a UE, and the uplink (UL), also called the reverse link, refers to the communication link from a UE to a Node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a serving GPRS support node (SGSN) 118 and a gateway GPRS support node (GGSN) 120. GPRS, which stands for General Packet Radio Service, is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a Node B 108 and a UE 110, but divides uplink and downlink transmissions into different time slots in the carrier.

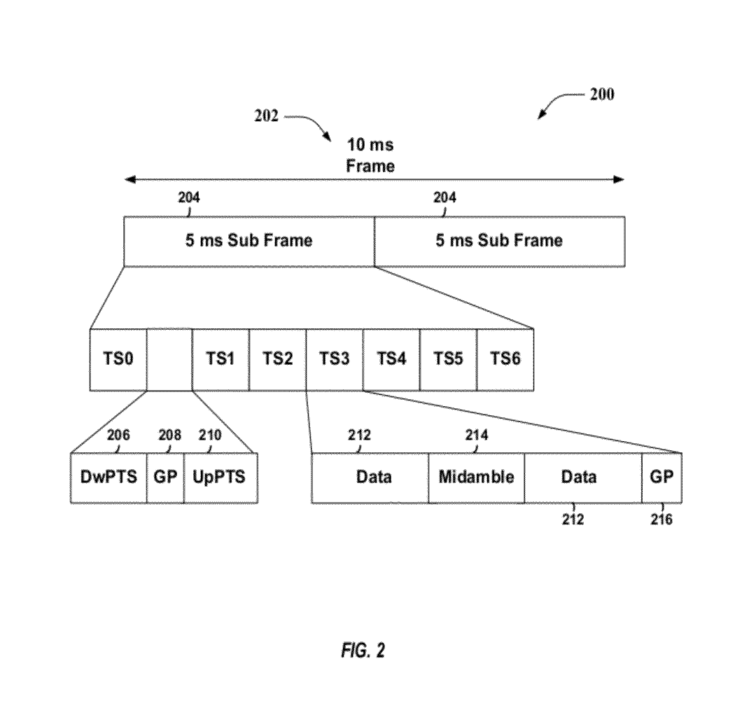

FIG. 2 shows a frame structure 200 for a TD-SCDMA carrier. The TD-SCDMA carrier, as illustrated, has a frame 202 that is 10 ms in length. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 separated by a midamble 214 and followed by a guard period (GP) 216. The midamble 214 may be used for features, such as channel estimation, while the GP 216 may be used to avoid inter-burst interference.

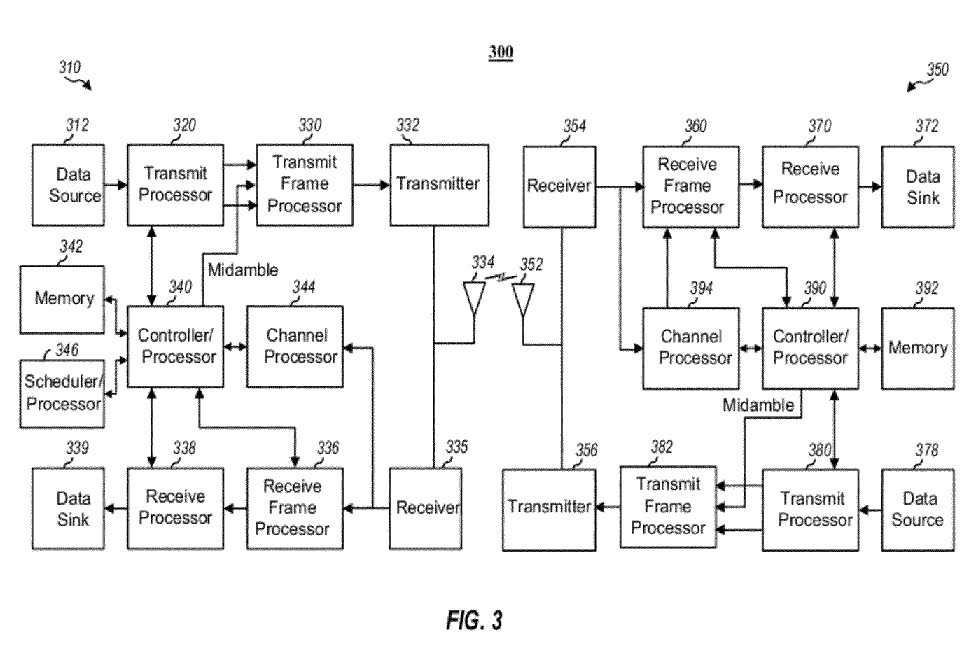

FIG. 3 is a block diagram of a Node B 310 in communication with a UE 350 in a RAN 300, where the RAN 300 may be the RAN 102 in FIG. 1, the Node B 310 may be the Node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the Node B 310. More specifically, the receive processor 370 descrambles and despreads the symbols, and then determines the most likely signal constellation points transmitted by the Node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receiver processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the Node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the Node B 310 or from feedback contained in the midamble transmitted by the Node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the Node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

The controller/processors 340 and 390 may be used to direct the operation at the Node B 310 and the UE 350, respectively. For example, the controller/processors 340 and 390 may provide various functions including timing, peripheral interfaces, voltage regulation, power management, and other control functions. The computer readable media of memories 342 and 392 may store data and software for the Node B 310 and the UE 350, respectively. A scheduler/processor 346 at the Node B 310 may be used to allocate resources to the UEs and schedule downlink and/or uplink transmissions for the UEs.

In one aspect, controller/processors 340 and 390 may enable enhanced FDE. In one configuration, the apparatus 350 for wireless communication includes means for receiving one or more signals from one or more cells over one or more channels where each channel is described using a channel vector and a spreading vector, and where each signal includes one or more data blocks each including a number of symbols, means for converting the one or more received signals from a time domain into a frequency domain using a block FFT, means for inverting a covariance matrix, wherein the covariance matrix is derived from a linear convolution of the one or more channel vectors and the one or more spreading vectors, and means for determining one or more MMSE signals by manipulating the frequency domain one or more received signals by applying the inverted equivalent channel matrix. In one aspect, the means for receiving may include receiver 354. In another aspect, the means for converting, inverting and determining may include controller/processor 390. In another configuration, the apparatus 350 includes means for using FFTs to arrange the covariance matrix into a block diagonal matrix, wherein the number of blocks in the block diagonal matrix is equal to the number of symbols. In another configuration, the apparatus 350 includes means for determining at least one of the one or more channels that is not flat, and means for inverting each block in the block diagonal matrix associated with the at least one of the one or more channels that is not flat. In another configuration, the apparatus 350 includes means for iteratively inversing the block diagonal matrix. In another configuration, the apparatus 350 includes means for determining a SINR using the inverted equivalent channel matrix and a covariance matrix associated with the frequency domain one or more received signals. In another configuration, the apparatus 350 includes means for determining a SINR for each of the one or more channels using the inverted equivalent channel matrix and a covariance matrix associated with the frequency domain one or more received signals. In another configuration, the apparatus 350 includes means for populating the inverted equivalent channel matrix and the covariance matrix are populated using at least one of measured values or estimated values.

In one aspect, the aforementioned means may be the processor(s) 360, 380 and/or 390 configured to perform the functions recited by the aforementioned means. In another aspect, the aforementioned means may be a module or any apparatus configured to perform the functions recited by the aforementioned means.

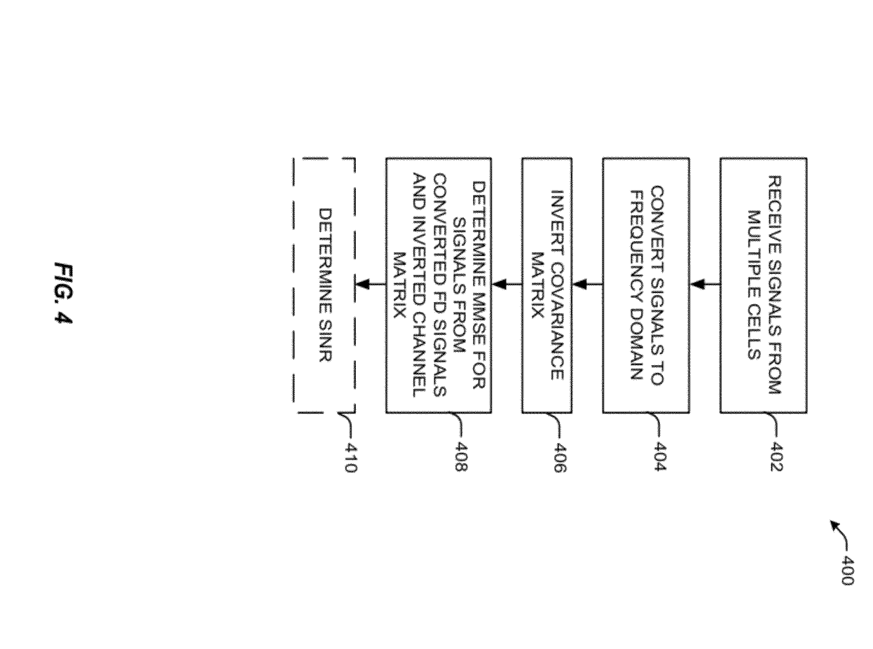

FIG. 4 illustrates various methodologies in accordance with various aspects of the presented subject matter. While, for purposes of simplicity of explanation, the methodologies are shown and described as a series of acts or sequence steps, it is to be understood and appreciated that the claimed subject matter is not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the claimed subject matter. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

FIG. 4 is a functional block diagram 400 illustrating example blocks executed in conducting wireless communication according to one aspect of the present disclosure. Generally, a received sample vector r may be converted into the frequency domain with a block FFT matrix F_{Q}. In the frequency domain, N smaller MMSE problems involving a 16×16 matrix inversion and a multiplication of K×16 matrix with the inverted matrix may be performed to process the received sample vector. Thereafter, the signal may be converted back to the time domain.

In block 402, a UE may receive one or more streams from one or more cells. In one aspect, in during reception of a TD-SCDMA downlink, a few strong cells may interfere with each other. In one aspect, the UE may use an enhanced receiver to more efficiently process downlink data by taking advantage of colored other cell interferences. In one aspect, Kᵢ streams may transmitted from cell(i) and each data block may have N symbols. In such an aspect, the k^{th} transmitted stream vector (s_{i,k}) is may be expressed in equation (1), and a spreading code (wₖ) may have a length Q=16 and may be expressed in equation (2).

s_{i,k}=[s_{i,k,1} s_{i,k,2} . . . s_{i,k,N}]^{T} (1)

wₖ=[w_{k,1} w_{k,2} . . . w_{k,Q}]^{T} (2)

Further, a spreading process of s_{i,k} can be modeled as a matrix multiplication where the spreading matrix may be a block diagonal with dimension NQ×N as expressed in equation (3).

C_{i,k}=I_{N} [symbol] (pᵢ⊙wₖ) (3)

Where, the symbol [symbol] stands for the kronecker product, e.g., each entry of N-dimensional identity matrix I_{N} is replaced by the vector in the bracket. Further, the symbol ⊙ denotes the Hadamard or element wise product. Still further, pᵢ is the 16×1 scrambling vector for cell i.

In one aspect, spreading vector C_{i,k}sₖ of the spreading matrix may go through an equivalent multipath channel with L≦16 taps, as expressed by the channel vector presented in equation (4).

\tilde{h}_{i,k}=[\tilde{h}_{k,0} \tilde{h}_{k,1} . . . \tilde{h}_{k,L-1}]^{T} (4)

Further, a linear convolution may be performed between channel vector \tilde{h}_{i,k} and spreading vector C_{i,k}sₖ and may be expressed by multiplying with a Toeplitz matrix, as expressed in equation (5).

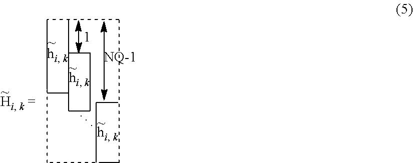

In one aspect, since the dimension of the Toeplitz matrix may be (NQ+L−1)×NQ, vector resulting after the convolution discussed above may have a length NQ+L−1. As such, signals received from multiple cells may be expressed as a vector r in equation (6).

$$r = {\sum }_{i = 1}^{n} {\sum }_{k = 1}^{{K}_{i}} {\tilde{H}}_{i , k} {C}_{i , k} {s}_{i , k} + v := {\sum }_{i = 1}^{n} {\sum }_{k = 1}^{{K}_{i}} {B}_{i , k} {s}_{i , k} + v \qquad ( 6 )$$

Where Kᵢ may be the number of streams in cell i and v is modeled as an additive white Gaussian noise (AWGN) vector with CN(0, σ²I). In one aspect, a symbol level equivalent channel matrix B_{i,k} of size (NQ+L−1)×N may be generated by combining channel and spreading vectors. Additionally, B_{i,k} may be structured as described in equation (7).

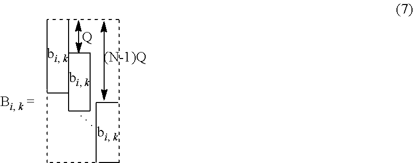

Where b_{i,k} has length Q+L−1 and is a linear convolution of the channel and scrambled Walsh vectors, which is expressed in equation (8).

b_{i,k}=\tilde{h}_{i,k}*(pᵢ⊙wₖ) (8)

In one aspect, a UE may attempt to demodulate the first K streams from a cell (e.g., cell 1). In such an aspect, K≦K₁≦K₁₆ and the received signal vector may be rewritten as expressed in equation (9).

$$r = {\sum }_{k = 1}^{K} {B}_{1 , k} {s}_{1 , k} + {\sum }_{k = K + 1}^{{K}_{1}} {B}_{1 , k} {s}_{1 , k} + {\sum }_{i = 2}^{n} {\sum }_{k = 1}^{{K}_{i}} {B}_{i , k} {s}_{i , k} + v \qquad ( 9 )$$

where the first term describes a selected signal component, the second term describes intra cell interference, the third term describes out of cell interference, and the last term is the AWGN. Further, the selected signal component from equation (9) may be rewritten and expressed in equation (10) as a vector.

$${\sum }_{k = 1}^{K} {B}_{1 , k} {s}_{1 , k} = {[ \begin{matrix}{B}_{1 , 1} & {B}_{1 , 2} & … & {B}_{1 , K}\end{matrix} ] [ \begin{matrix}{s}_{1 , 1}^{T} & {s}_{1 , 2}^{T} & … & {s}_{1 , K}^{T}\end{matrix} ]}^{T} \qquad ( 10 )$$

Additionally, the vector expressed in equation (10) may be manipulated into a matrix with a Toeplitz structure as seen in equation (11).

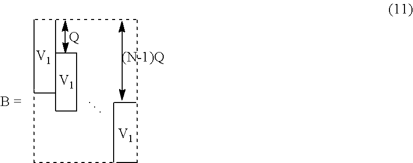

Equation (11) describes a matrix in which all first columns from B_{1,1} . . . B_{1,K} and make up the first K columns of B, all second columns from B_{1,1} . . . B_{1,K} make up the second K columns of B, etc. As used herein, V₁=[b_{1,1} b_{1,2} b_{1,K}]. As such, after row permutations, the selected symbol vector may be expressed in equation (12).

s=[s_{1,1,1} . . . s_{1,K,1} s_{1,1,2} . . . s_{1,K,2} . . . s_{1,1,N} . . . s_{1,K,N}]^{T} (12)

As such, the received signal vector may be reformulated to be expressed in equation (13).

$$r = Bs + {\sum }_{k = K + 1}^{{K}_{1}} {B}_{1 , k} {s}_{1 , k} + {\sum }_{i = 2}^{n} {\sum }_{k = 1}^{{K}_{i}} {B}_{i , k} {s}_{i , k} + v \qquad ( 13 )$$

Where equivalent channel matrix B and desired vector s have dimensions (NQ+L−1)×(KN) and (KN)×1. Further, a optimal linear MMSE for s may be expressed in equation (14).

ŝₘₘₛₑ=B^{H}Rᵣᵣ⁻¹r (14)

Where Rᵣᵣ is a correlation matrix expressed by equation (15).

$${R}_{rr} = {\sum }_{i = 1}^{n} {\sum }_{k = 1}^{{K}_{i}} {B}_{i , k} {B}_{i , k}^{H} + {σ}^{2} I \qquad ( 15 )$$

Generally, it can be noted that Walsh cover, scrambling codes, and physical channels may all be considered as part of each equivalent discrete time channel.

In block 404, the received signals may be converted into the frequency domain. Generally, to convert a time domain based signal to a frequency base a FFT may be used. In one aspect, direct inversion of Rᵣᵣ, as described in equation (15), may be prohibitively high complexity, a circulant matrix approximation of the Toeplitz matrices B_{i,k} for all i and k may be used to form a block diagonalized matrix. Specifically, a size NQ×N matrix may be used to approximate B_{i,k}.

Generally, a block circulant matrix can be converted into a block diagonal matrix using a block FFT matrix. Inverting a block diagonal matrix involves inverting smaller matrices on its diagonal, which may incur lower computational complexity. As sued herein, for a matrix with size DQ×DK to be block circulant with block size (Q, K), it needs to satisfy: entry (i, j)=entry ((i+Q)mod DQ, (j+K)mod DK) for all iε{0, . . . , DQ−1} and jε{0, . . . , DK−1}. Further, an example application of a block FFT matrix to a block circulant matrix is provided in equation (16), where the block FFT matrix is defined by equation (17).

C_{(Q,K)}=F_{Q}⁻¹Δ_{(Q,K)}F_{K} (16)

Fₙ=F [symbol] Iₙ (17)

The block diagonal matrix has block size Q×K on the diagonals and diagonal blocks can be computed using equation (18).

diag(Δ_{(Q,K)})=F_{Q}C_{(Q,K)}(:,1:K) (18)

As such, B_{i,k} may be converted into a frequency domain based matrix using equation (19).

B_{i,k}=F_{Q}⁻¹Δ_{i,k}F₁ (19)

Where Δ_{i,k} is NQ×N dimensional block diagonal with block size Q×1.

In block 406, the UE may invert the covariance (e.g., correlation matrix (Rᵣᵣ)). In one aspect, the approximated B_{i,k} may be substituted into the inverse of equation (15) to yield equation (20).

$${R}_{rr}^{- 1} \approx {{F}_{Q}^{- 1} ( {\sum }_{i = 1}^{n} {\sum }_{k = 1}^{{K}_{i}} {Δ}_{i , k} {Δ}_{i , k}^{H} + {σ}^{2} I )}^{- 1} {F}_{Q} \qquad ( 20 )$$

Where Δ_{i,k}Δ_{i,k}^{H} may be block diagonal with 16×16 blocks on the diagonal. In one aspect, each such 16×16 matrices may have a rank of 1. Nonetheless, after adding all cells, streams and AWGN, all 16×16 matrices may be full rank. As such, equation (20) demonstrates that inverting Rᵣᵣ is decomposed into N inversions of 16×16 matrices, which is a significant complexity reduction. Substituting Rᵣᵣ⁻¹ back into equation (14) yields equation (21).

$${\hat{s}}_{mmse} = {( {F}_{Q} B )}^{H} {( {\sum }_{i = 1}^{n} {\sum }_{k = 1}^{{K}_{i}} {Δ}_{i , k} {Δ}_{i , k}^{H} + {σ}^{2} I )}^{- 1} ( {F}_{Q} r ) \qquad ( 21 )$$

In one aspect, a second set of cicrulant approximations may be performed on B, as described in equation (22).

B=F_{Q}⁻¹Δ_{B}F_{K} (22)

Further, Since B corresponds to K streams, the block size on the diagonal of Δ_{B} is a Q×K sized matrix.

In one aspect, additional matrix processing may be used to reduce inversion complexity. In one aspect, channel frequency domain coherent bandwidth analysis may be used. In such an aspect, as noted above, the correlation matrix Rᵣᵣ may be block diagonal with 16×16 matrices on the diagonal defined as R_{rr,i}, i=1 . . . N. These R_{rr,i} matrices may be highly correlated. For example, if the physical channels from all cells are flat, then N identical R_{rr,i} matrices are formed. In such an aspect, by dividing each time slot into 4 segments of (e.g., 11×16=176 chips each), instead of N=11 matrix inversions, we only need to perform Nᵣ, (e.g., 4), such inversions. As such, by adapting Nᵣ based on channel conditions or affordable complexity levels, complexity and performance tradeoffs may be managed. In another aspect, iterative matrix inversion may be used to reduce complexity. For example, when serving and interfering cells both have 2 active Walsh codes, an iterative matrix inversion approach provides an efficient alternative to direct inversion. In one example, each 16×16 R_{rr,i} matrix in a generic form as described in equation (23).

X=aI+buu^{H}+cvv^{H}:=X₀+cvv^{H} (23)

Where u and v are 16×2 matrices and a, b, c are scalars. For iterative inversion of X, X₀ (as described in equation (24)) is inverted.

$${X}_{0}^{- 1} = \frac{1}{a} [ I - {u ( \frac{1}{b} I + \frac{1}{a} {u}^{H} u )}^{- 1} {u}^{H} ] \qquad ( 24 )$$

Inversion of X₀ only involves a single 2×2 matrix inversion and some other multiplication operations. Thereafter, X may be inverted based on an updated inverted X₀ as described in equation (25).

X⁻¹=X₀⁻¹−v(I/c+v^{H}X₀⁻¹v)⁻¹v^{H} (25)

One may note that the updated X can be computed with similarly low complexity as was used to compute X₀.

In block 408 the MMSE is determined for one or more received signals. In one aspect, equation (22) may be substituted back into equation (21) to provide an MMSE estimator, as described in equation (23).

$${\hat{s}}_{mmse} = {F}_{K}^{H} \cdot {{Δ}_{B}^{H} ( {\sum }_{i = 1}^{n} {\sum }_{k = 1}^{{K}_{i}} {Δ}_{i , k} {Δ}_{i , k}^{H} + {σ}^{2} I )}^{- 1} \cdot {F}_{Q} r \qquad ( 26 )$$

In block 410, additionally or optionally a SINR may also be determined. In one aspect, factorization based Cholesky decompositions and back substitutions to compute matrix inversions used to determine the SINR expression. In one aspect, per Walsh channel SINR values may be determined through frequency domain formulations. In one aspect, a received signal r may be described in the frequency domain (\tilde{r}) through equation (27). A covariance matrix associated with re frequency domain vector is described in equation (28), and a frequency domain equalizer weight is described in equation (29).

$$\begin{matrix}\tilde{r} := {F}_{Q} r = {F}_{Q} Bs + \tilde{n} = {Δ}_{B} {F}_{K} s + \tilde{n} = {Δ}_{B} \tilde{s} + \tilde{n} & ( 27 ) \\ {R}_{\tilde{r} \tilde{r}} = {\sum }_{i = 1}^{n} {\sum }_{k = 1}^{{K}_{i}} {Δ}_{i , k} {Δ}_{i , k}^{H} + {σ}^{2} I & ( 28 ) \\ {W}_{F} = {Δ}_{B}^{H} {R}_{\tilde{r} \tilde{r}}^{- 1} = {{Δ}_{B}^{H} ( {\sum }_{i = 1}^{n} {\sum }_{k = 1}^{{K}_{i}} {Δ}_{i , k} {Δ}_{i , k}^{H} + {σ}^{2} I )}^{- 1} & ( 29 )\end{matrix}$$

Taking into account the above described equations, an expression for an averaged SINR over all K active Walsh channels is described in equation (30).

$$\begin{matrix}SINR = \frac{tr ( ( {W}_{F} {Δ}_{B} ) ⊙ {( {W}_{F} {Δ}_{B} )}^{H} )}{tr ( {W}_{F} {R}_{\tilde{r} \tilde{r}} {W}_{F}^{H} ) - tr ( ( {W}_{F} {Δ}_{B} ) ⊙ {( {W}_{F} {Δ}_{B} )}^{H} )} \\ = \frac{1}{\frac{tr ( {W}_{F} {R}_{\tilde{r} \tilde{r}} {W}_{F}^{H} )}{tr ( ( {W}_{F} {Δ}_{B} ) ⊙ {( {W}_{F} {Δ}_{B} )}^{H} )} - 1}\end{matrix} \qquad ( 30 )$$

Where tr denotes trace of a matrix and ⊙ is the entry wise product. Equation (30) may be reformulated to eliminate W_{F} where only the SINR value is of interest, as seen in equation (31).

$$\begin{matrix}V := \frac{tr ( {W}_{F} {R}_{\tilde{r} \tilde{r}} {W}_{F}^{H} )}{tr ( ( {W}_{F} {Δ}_{B} ) ⊙ {( {W}_{F} {Δ}_{B} )}^{H} )} \\ = \frac{tr ( {Δ}_{B}^{H} {R}_{\tilde{r} \tilde{r}}^{- 1} {Δ}_{B} )}{tr ( {diag ( {Δ}_{B}^{H} {R}_{\tilde{r} \tilde{r}}^{- 1} {Δ}_{B} )}^{2} )}\end{matrix} \qquad ( 31 )$$

Further, as both Δ_{B} and Rᵣᵣ are block diagonal, V may be reformatted as described in equation (32)

$$\begin{matrix}V = \frac{{\sum }_{i = 1}^{N} tr ( {Δ}_{B , i}^{H} {R}_{\tilde{r} \tilde{r} , i}^{- 1} {Δ}_{B , i} )}{{\sum }_{i = 1}^{N} tr ( {diag ( {Δ}_{B , i}^{H} {R}_{\tilde{r} \tilde{r} , i}^{- 1} {Δ}_{B , i} )}^{2} )} \\ = \frac{{\sum }_{i = 1}^{N} {\sum }_{j = 1}^{K} {d}_{B , i , j}^{H} {R}_{\tilde{r} \tilde{r} , i}^{- 1} {d}_{B , i , j}}{{\sum }_{i = 1}^{N} {\sum }_{j = 1}^{K} {\vert {d}_{B , i , j}^{H} {R}_{\tilde{r} \tilde{r} , i}^{- 1} {d}_{B , i , j} \vert}^{2}}\end{matrix} \qquad ( 32 )$$

Where i denotes the block index, d_{B, i, j} is the jth column vector of Δ_{B,i}, and there are N diagonal blocks. Equation (32) indicates that one of the building blocks for an SINR calculation is d_{B, i, k}^{H}Rᵣᵣ⁻¹d_{B, i, j}.

In one aspect, to determine a SINR value, factorization based Cholesky decomposition may be used for matrix inversions, as described in equation (33).

R_{\tilde{r}\tilde{r},i}=LDL^{H} (33)

Where L is a lower diagonal matrix with 1 on the diagonal and D is diagonal with non-negative entries. In one aspect, application of equation (33) allows one to avoid using a squared root operation. Substituting equation (33) into the SINR building block, results in equation (34).

d_{B,i,k}^{H}R_{\tilde{r}\tilde{r},i}⁻¹d_{B,i,j}=(L⁻¹d_{B,i,j})^{H}D⁻¹(L⁻¹d_{B,i,j}) (34)

Where he computation of L⁻¹d_{B, i, j} can be done by solving equation (35).

Lx=d_{B,i,j} (35)

Further, as L is a lower triangular matrix, this equation can be solved with back substitutions, resulting in the building block value be described in equation (36).

d_{B,i,k}^{H}R_{\tilde{r}\tilde{r},i}⁻¹d_{B,i,j}=x^{H}D⁻¹x (36)

As such, per Walsh channel averaged SINR can be computed using equation (36), where SINRₖ=1/(Vₖ−1), and where Vk is defined by equation (37).

$${V}_{k} = \frac{{\sum }_{i = 1}^{N} {d}_{B , i , k}^{H} {R}_{\tilde{r} \tilde{r} , i}^{- 1} {d}_{B , i , k}}{{\sum }_{i = 1}^{N} {\vert {d}_{B , i , k}^{H} {R}_{\tilde{r} \tilde{r} , i}^{- 1} {d}_{B , i , k} \vert}^{2}} \qquad ( 37 )$$

In another aspect, a UE frequency domain channel matrix Δ_{B} and covariance matrix Rᵣᵣ of the received samples may be estimated. In such an aspect, the associated estimation error for these parameters may degrade optimal FDE performance. Based on estimated channel and covariance matrices the frequency domain equalizer weight matrix may be determined using equation (29). In one aspect, it may be assumed that the estimated Δ_{B} and Rᵣᵣ matrices also have block diagonal structure. As such, the inversion of estimated Rᵣᵣ is degraded into a number of smaller problems with dimension 16×16, sa described in equation (33). Applying equation (33) to equation (29) yields equation (38).

Ŵ_{F,i}=\hat{Δ}_{B,i}^{H}\hat{R}_{\tilde{r}\tilde{r},i}⁻¹=(L⁻¹\hat{Δ}_{B,i})^{H}D⁻¹L⁻¹:=X^{H}D⁻¹L⁻¹ (38)

Where Δ_{B,i} is the i^{th} diagonal block of Δ_{B} and has dimension 16×K. Again, matrix X can be solved with back substitutions, as described in equation (35). Thereafter, Y may be defined as Y:=X^{H}D⁻¹ and substituted into equation (38) to yield equation (39).

Ŵ_{F,i}L=Y (39)

Where Ŵ_{F,i} is defined using equation (40).

Ŵ_{F,i}:=[wᵢ₁^{H} wᵢ₂^{H} . . . w_{iK}^{H}]^{H} and Ŵ_{F,i}Δ_{B,i}:=[C_{i,jk}] (40)

In one aspect, Δ_{B} and Rᵣᵣ may be true channel and covariance matrices or the estimated channel and covariance matrices. Where estimated values are used, the SINR value becomes a predicted SINR. In one such, the predicted SINR may be useful for default midamble schemes, where Walsh channel SINR cannot be estimated based on equalized midamble symbols. Further, the per Walsh SINR may be determined by substituting equation (40) into equation (30) to yield equation (41).

$${V}_{k} = \frac{{\sum }_{i = 1}^{N} {w}_{ik} {R}_{\tilde{r} \tilde{r} , i}^{- 1} {w}_{ik}^{H}}{{\sum }_{i = 1}^{N} {\vert {C}_{i , kk} \vert}^{2}} \qquad ( 41 )$$

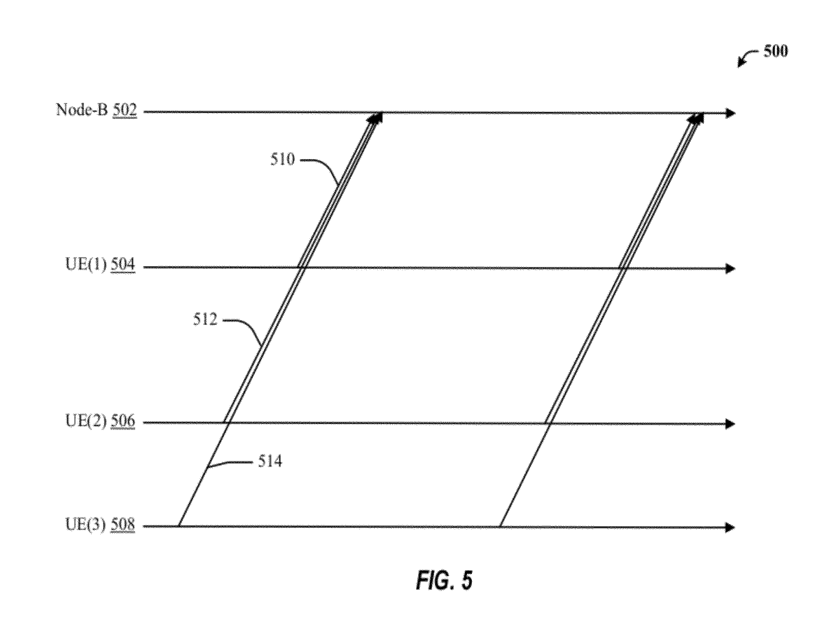

FIG. 5 is a diagram conceptually illustrating an exemplary TD-SCDMA based system 500 with multiple UEs communicating with a node B as time progresses according to one aspect of the present disclosure. Generally, in TD-SCDMA systems, multiple UEs may share a common bandwidth in communication with a node B 502. Additionally, one aspect in TD-SCDMA systems, as compared to CDMA and WCDMA systems, is UL synchronization. That it, in TD-SCDMA systems, different UEs (504, 506, 508) may synchronize on the uplink (UL) such that all UEs (504, 506, 508) transmitted signals arrives at the node B at approximately the same time. For example, in the depicted aspect, various UEs (504, 506, 508) are located at various distances from the serving node B 502. Accordingly, in order for the UL transmission to reach the node B 502 at approximately the same time, each UE may originate transmissions at different times. For example, UE(3) 508 may be farthest from node B 502 and may perform an UL transmission 514 before closer UEs. Additionally, UE 506(2) may be closer to node B 502 than UE(3) 508 and may perform an UL transmission 512 after UE(3) 508. Similarly, UE(1) 504 may be closer to node B 502 than UE(2) 506 and may perform an UL transmission 510 after UE(2) 506 and UE(3) 508. The timing of the UL transmissions (510, 512, 514) may be such that the signals arrive at the node B at approximately the same time.

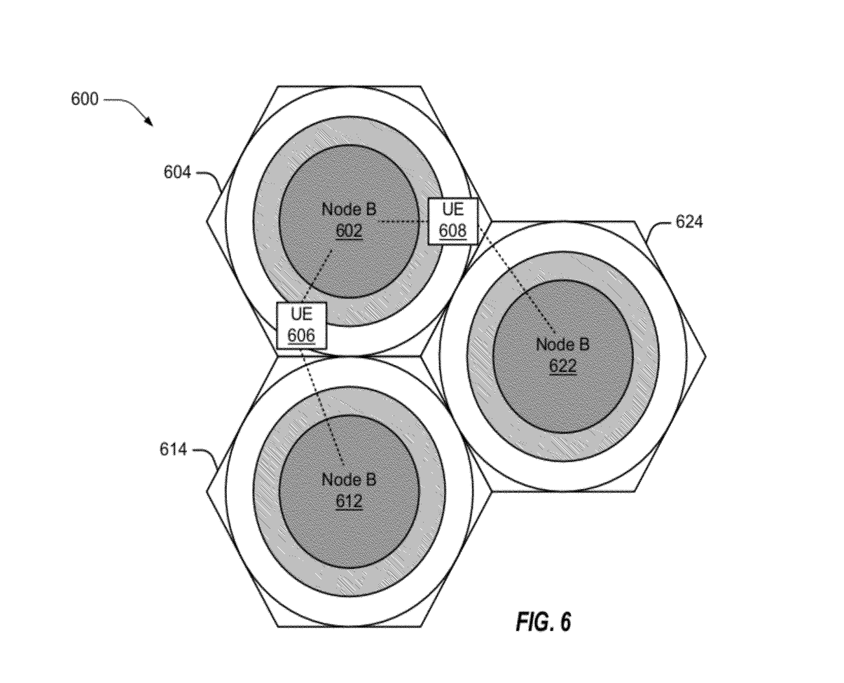

With reference now to FIG. 6, a diagram conceptually illustrating an exemplary wireless communications system 600 is presented. System 600 may include multiple Node Bs (602, 612, 622), where each Node B serves a region (e.g. cell), such as regions 604, 614 and 624 respectively. In one aspect, a serving Node B 602 may service multiple UEs (606, 608). Additionally, a UE may receive signals from more than one Node B (e.g., UE 606 receives signals from Node Bs 602 and 612). For the UE to be able to process a serving cells 602 signals, interference from other cells (612, 622) may be removed or reduced. In one aspect, UE 606 may include a FDE enabled to efficiently reduce other cell interference.

In one aspect, serving Node B may allocation resources to UEs (606, 608) in such a manner as to attempt to minimize interference with a neighboring cell which is experiencing high load conditions (e.g. 612), and/or maximizing data rates for UEs located where interference with a neighboring cell is not relevant. In one such aspect, a UE may be located near the serving Node B, and as such, neighbor cell interference is not a concern. In another aspect, a UE may be located near a cell 624 served by a Node B 622 which is not experiencing a high load. In such an aspect, the serving Node B may allocate a higher data rate to the UE 608 without concern regarding other cell 624 interference. Operation of such interference processing is depicted in FIG. 4.

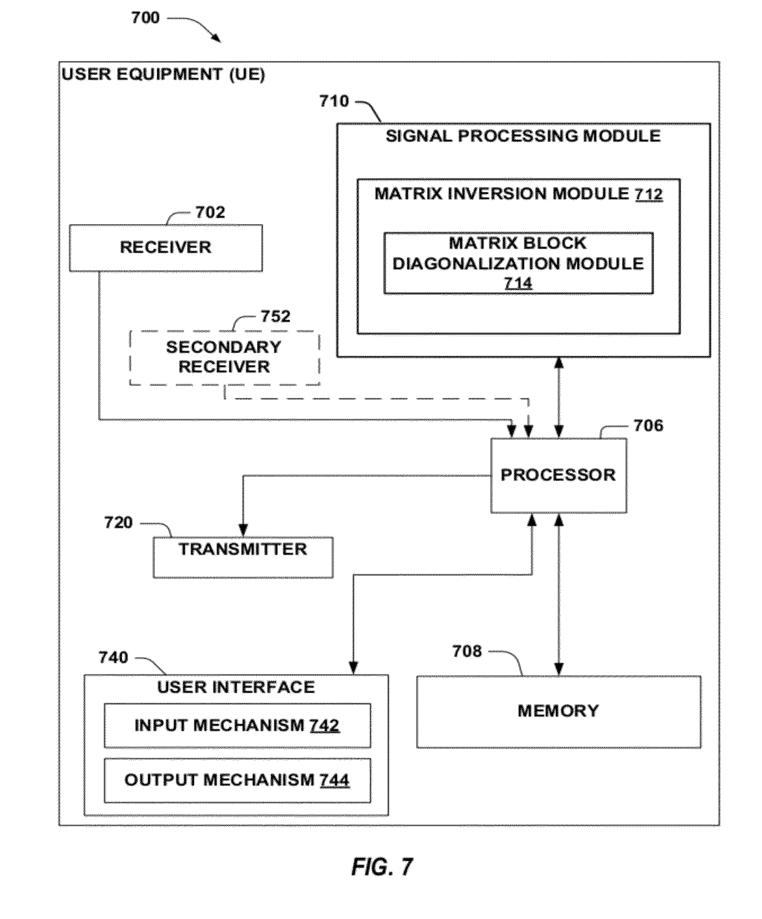

With reference now to FIG. 7, an illustration of a UE 700 (e.g. a client device, wireless communications device (WCD), etc.) that can facilitate efficient interference reduction is presented. UE 700 comprises receiver 702 that receives one or more signal from, for instance, one or more receive antennas (not shown), performs typical actions on (e.g., filters, amplifies, downconverts, etc.) the received signal, and digitizes the conditioned signal to obtain samples. Receiver 702 can further comprise an oscillator that can provide a carrier frequency for demodulation of the received signal and a demodulator that can demodulate received symbols and provide them to processor 706 for channel estimation. In one aspect, UE 700 may further comprise secondary receiver 752 and may receive additional channels of information.

Processor 706 can be a processor dedicated to analyzing information received by receiver 702 and/or generating information for transmission by one or more transmitters 720 (for ease of illustration, only one transmitter is shown), a processor that controls one or more components of UE 700, and/or a processor that both analyzes information received by receiver 702 and/or receiver 752, generates information for transmission by transmitter 720 for transmission on one or more transmitting antennas (not shown), and controls one or more components of UE 700.

UE 700 can additionally comprise memory 708 that is operatively coupled to processor 706 and that can store data to be transmitted, received data, information related to available channels, data associated with analyzed signal and/or interference strength, information related to an assigned channel, power, rate, or the like, and any other suitable information for estimating a channel and communicating via the channel. Memory 708 can additionally store protocols and/or algorithms associated with estimating and/or utilizing a channel (e.g., performance based, capacity based, etc.).

It will be appreciated that the data store (e.g., memory 708) described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable PROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Memory 708 of the subject systems and methods is intended to comprise, without being limited to, these and any other suitable types of memory.

UE 700 can further comprise resource signal processing module 710 which may be operable to process signals received by UE 700. In one aspect, signal processing module 710 may include matrix inversion module 712 and matrix block diagonalization module 714. In one aspect, matrix inversion module 712 is operable calculate MMSE signals from one or more cells. In one aspect, matrix inversion module 712 may invert matrices populated with values associated with the received signalsing using matrix block diagonalization module 714. In one aspect, matrix block diagonalization module 714 may process a matrix by structuring values into a block diagonal matrix through application of a FFT and inverting the structured matrix. Operation of such matrix processing is depicted in FIG. 4.

Moreover, in one aspect, processor 706 may provide the means for receiving one or more signals from one or more cells over one or more channels where each channel is described using a channel vector and a spreading vector, and where each signal includes one or more data blocks each including a number of symbols, means for converting the one or more received signals from a time domain into a frequency domain using a block FFT, means for inverting an equivalent channel matrix, wherein the equivalent channel matrix is derived from a linear convolution of the one or more channel vectors and the one or more spreading vectors and arranged to create a block diagonal matrix, and means for determining one or more MMSE signals by manipulating the frequency domain one or more received signals by applying the inverted equivalent channel matrix.

Additionally, UE 700 may include user interface 740. User interface 740 may include input mechanisms 742 for generating inputs into UE 700, and output mechanism 742 for generating information for consumption by the user of UE 700. For example, input mechanism 742 may include a mechanism such as a key or keyboard, a mouse, a touch-screen display, a microphone, etc. Further, for example, output mechanism 744 may include a display, an audio speaker, a haptic feedback mechanism, a Personal Area Network (PAN) transceiver etc. In the illustrated aspects, output mechanism 744 may include a display operable to present content that is in image or video format or an audio speaker to present content that is in an audio format.

Several aspects of a telecommunications system has been presented with reference to a TD-SCDMA system. As those skilled in the art will readily appreciate, various aspects described throughout this disclosure may be extended to other telecommunication systems, network architectures and communication standards. By way of example, various aspects may be extended to other UMTS systems such as W-CDMA, HSDPA, High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication, comprising:
receiving one or more signals from one or more cells over one or more channels where each channel is described using a channel vector and a spreading vector, and where each signal includes one or more data blocks each including a number of symbols;
converting the one or more received signals from a time domain into a frequency domain using a block fast Fourier transform (FFT);
inverting a covariance matrix, wherein the covariance matrix is derived from a linear convolution of the one or more channel vectors and the one or more spreading vectors; and
determining one or more minimum mean square error (MMSE) signals by manipulating the frequency domain one or more received signals by applying the inverted equivalent channel matrix.

2. The method of claim 1, wherein the inverting further comprises using FFTs to arrange the covariance matrix into a block diagonal matrix, wherein the number of blocks in the block diagonal matrix is equal to the number of symbols.

3. The method of claim 2, wherein the inverting further comprises:
determining at least one of the one or more channels that is not flat;
inverting each block in the block diagonal matrix associated with the at least one of the one or more channels that is not flat.

4. The method of claim 2, wherein the inverting further comprises iteratively inversing the block diagonal matrix.

5. The method of claim 1, further comprising determining a signal to interference and noise ratio (SINR) using the inverted equivalent channel matrix and a covariance matrix associated with the frequency domain one or more received signals.

6. The method of claim 1, further comprising determining a SINR for each of the one or more channels using the inverted equivalent channel matrix and a covariance matrix associated with the frequency domain one or more received signals.

7. The method of claim 1, wherein the determined one or more MMSE signals (ŝₘₘₛₑ) are described by the expression ŝₘₘₛₑ=F_{K}^{H}·Δ_{B}^{H}(Σᵢ₌₁ⁿΣₖ₌₁^{K}^{ᵢ}Δ_{i,k}Δ_{i,k}^{H}+σ2I−1·FQr.

8. The method of claim 5, further comprising populating the inverted equivalent channel matrix and the covariance matrix are populated using at least one of measured values or estimated values.

9. The method of claim 5, wherein the SINR is described by the expression
$$\frac{{\sum }_{i = 1}^{N} {\sum }_{j = 1}^{K} {d}_{B , i , j}^{H} {R}_{\tilde{r} \tilde{r} , i}^{- 1} {d}_{B , i , j}}{{\sum }_{i = 1}^{N} {\sum }_{j = 1}^{K} {\vert {d}_{B , i , j}^{H} {R}_{\tilde{r} \tilde{r} , i}^{- 1} {d}_{B , i , j} \vert}^{2}} .$$

10. The method of claim 6, wherein the SINR is described by the expression
$$\frac{{\sum }_{i = 1}^{N} {d}_{B , i , j}^{H} {R}_{\tilde{r} \tilde{r} , i}^{- 1} {d}_{B , i , j}}{{\sum }_{i = 1}^{N} {\vert {d}_{B , i , j}^{H} {R}_{\tilde{r} \tilde{r} , i}^{- 1} {d}_{B , i , j} \vert}^{2}} .$$

11. An apparatus for wireless communication, comprising:
means for receiving one or more signals from one or more cells over one or more channels where each channel is described using a channel vector and a spreading vector, and where each signal includes one or more data blocks each including a number of symbols;
means for converting the one or more received signals from a time domain into a frequency domain using a block FFT;
means for inverting a covariance matrix, wherein the covariance matrix is derived from a linear convolution of the one or more channel vectors and the one or more spreading vectors; and
means for determining one or more minimum mean square error (MMSE) signals by manipulating the frequency domain one or more received signals by applying the inverted equivalent channel matrix.

12. The apparatus of claim 11, wherein the means for inverting further comprises means for using FFTs to arrange the covariance matrix into a block diagonal matrix, wherein the number of blocks in the block diagonal matrix is equal to the number of symbols.

13. The apparatus of claim 12, wherein the means for inverting further comprises:
means for determining at least one of the one or more channels that is not flat; and
means for inverting each block in the block diagonal matrix associated with the at least one of the one or more channels that is not flat.

14. The apparatus of claim 12, wherein the means for inverting further comprises means for iteratively inversing the block diagonal matrix.

15. The apparatus of claim 11, further comprising means for determining a SINR using the inverted equivalent channel matrix and a covariance matrix associated with the frequency domain one or more received signals.

16. The apparatus of claim 11, further comprising means for determining a SINR for each of the one or more channels using the inverted equivalent channel matrix and a covariance matrix associated with the frequency domain one or more received signals.

17. The apparatus of claim 11, wherein the determined one or more MMSE signals (ŝₘₘₛₑ) are described by the expression ŝₘₘₛₑ=F_{K}^{H}·Δ_{B}^{H}(Σᵢ₌₁ⁿΣₖ₌₁^{K}^{ᵢ}Δ_{i,k}Δ_{i,k}^{H}+σ2I−1·FQr.

18. The apparatus of claim 15, further comprising means for populating the inverted equivalent channel matrix and the covariance matrix are populated using at least one of measured values or estimated values.

19. The apparatus of claim 15, wherein the SINR is described by the expression
$$\frac{{\sum }_{i = 1}^{N} {\sum }_{j = 1}^{K} {d}_{B , i , j}^{H} {R}_{\tilde{r} \tilde{r} , i}^{- 1} {d}_{B , i , j}}{{\sum }_{i = 1}^{N} {\sum }_{j = 1}^{K} {\vert {d}_{B , i , j}^{H} {R}_{\tilde{r} \tilde{r} , i}^{- 1} {d}_{B , i , j} \vert}^{2}} .$$

20. The apparatus of claim 16, wherein the SINR is described by the expression
$$\frac{{\sum }_{i = 1}^{N} {d}_{B , i , j}^{H} {R}_{\tilde{r} \tilde{r} , i}^{- 1} {d}_{B , i , j}}{{\sum }_{i = 1}^{N} {\vert {d}_{B , i , j}^{H} {R}_{\tilde{r} \tilde{r} , i}^{- 1} {d}_{B , i , j} \vert}^{2}} .$$

21. A computer program product, comprising:
a computer-readable medium comprising code for:
receiving one or more signals from one or more cells over one or more channels where each channel is described using a channel vector and a spreading vector, and where each signal includes one or more data blocks each including a number of symbols;
converting the one or more received signals from a time domain into a frequency domain using a block FFT;
inverting a covariance matrix, wherein the covariance matrix is derived from a linear convolution of the one or more channel vectors and the one or more spreading vectors; and
determining one or more minimum mean square error (MMSE) signals by manipulating the frequency domain one or more received signals by applying the inverted equivalent channel matrix.

22. The computer program product of claim 21, wherein the computer-readable medium further comprises code for:
using FFTs to arrange the covariance matrix into a block diagonal matrix, wherein the number of blocks in the block diagonal matrix is equal to the number of symbols.

23. The computer program product of claim 22, wherein the computer-readable medium further comprises code for:
determining at least one of the one or more channels that is not flat; and
inverting each block in the block diagonal matrix associated with the at least one of the one or more channels that is not flat.

24. The computer program product of claim 22, wherein the computer-readable medium further comprises code for iteratively inversing the block diagonal matrix

25. The computer program product of claim 21, wherein the computer-readable medium further comprises code for:
determining a SINR using the inverted equivalent channel matrix and a covariance matrix associated with the frequency domain one or more received signals.

26. The computer program product of claim 21, wherein the computer-readable medium further comprises code for:
determining a SINR for each of the one or more channels using the inverted equivalent channel matrix and a covariance matrix associated with the frequency domain one or more received signals

27. The computer program product of claim 21, wherein the determined one or more MMSE signals (ŝₘₘₛₑ) are described by the expression ŝₘₘₛₑ=F_{K}^{H}·Δ_{B}^{H}(Σᵢ₌₁ⁿΣₖ₌₁^{K}^{ᵢ}Δ_{i,k}Δ_{i,k}^{H}+σ²I)⁻¹·F_{Q}r.

28. The computer program product of claim 25, wherein the computer-readable medium further comprises code for populating the inverted equivalent channel matrix and the covariance matrix are populated using at least one of measured values or estimated values.

29. The computer program product of claim 25, wherein the SINR is described by the expression
$$\frac{{\sum }_{i = 1}^{N} {\sum }_{j = 1}^{K} {d}_{B , i , j}^{H} {R}_{\tilde{r} \tilde{r} , i}^{- 1} {d}_{B , i , j}}{{\sum }_{i = 1}^{N} {\sum }_{j = 1}^{K} {\vert {d}_{B , i , j}^{H} {R}_{\tilde{r} \tilde{r} , i}^{- 1} {d}_{B , i , j} \vert}^{2}} .$$

30. The computer program product of claim 26, wherein the SINR is described by the expression
$$\frac{{\sum }_{i = 1}^{N} {d}_{B , i , j}^{H} {R}_{\tilde{r} \tilde{r} , i}^{- 1} {d}_{B , i , j}}{{\sum }_{i = 1}^{N} {\vert {d}_{B , i , j}^{H} {R}_{\tilde{r} \tilde{r} , i}^{- 1} {d}_{B , i , j} \vert}^{2}} .$$

31. An apparatus for wireless communication, comprising:
at least one processor; and
a memory coupled to the at least one processor,
a receiver configured to receive one or more signals from one or more cells over one or more channels where each channel is described using a channel vector and a spreading vector, and where each signal includes one or more data blocks each including a number of symbols;
wherein the at least one processor is configured to:
convert the one or more received signals from a time domain into a frequency domain using a block FFT;
invert equivalent covariance matrix, wherein the covariance matrix is derived from a linear convolution of the one or more channel vectors and the one or more spreading vectors; and
determine one or more minimum mean square error (MMSE) signals by manipulating the frequency domain one or more received signals by applying the inverted equivalent channel matrix.

32. The apparatus of claim 31, wherein the processor is further configured to:
use FFTs to arrange the covariance matrix into a block diagonal matrix, wherein the number of blocks in the block diagonal matrix is equal to the number of symbols.

33. The apparatus of claim 32, wherein the processor is further configured to:
determine at least one of the one or more channels that is not flat;
invert each block in the block diagonal matrix associated with the at least one of the one or more channels that is not flat.

34. The apparatus of claim 32, wherein the processor is further configured to:
iteratively invert the block diagonal matrix.

35. The apparatus of claim 31, wherein the processor is further configured to:
determine a signal to interference and noise ratio (SINR) using the inverted equivalent channel matrix and a covariance matrix associated with the frequency domain one or more received signals.

36. The apparatus of claim 31, wherein the processor is further configured to:
determine a SINR for each of the one or more channels using the inverted equivalent channel matrix and a covariance matrix associated with the frequency domain one or more received signals.

37. The apparatus of claim 31, wherein the determined one or more MMSE signals (ŝₘₘₛₑ) are described by the expression ŝₘₘₛₑ=F_{K}^{H}·Δ_{B}^{H}(Σᵢ₌₁ⁿΣₖ₌₁^{K}^{ᵢ}Δ_{i,k}Δ_{i,k}^{H}+σ2I−1·FQr.

38. The apparatus of claim 35, wherein the processor is further configured to:
populate the inverted equivalent channel matrix and the covariance matrix are populated using at least one of measured values or estimated values.

39. The apparatus of claim 35, wherein the SINR is described by the expression
$$\frac{{\sum }_{i = 1}^{N} {\sum }_{j = 1}^{K} {d}_{B , i , j}^{H} {R}_{\tilde{r} \tilde{r} , i}^{- 1} {d}_{B , i , j}}{{\sum }_{i = 1}^{N} {\sum }_{j = 1}^{K} {\vert {d}_{B , i , j}^{H} {R}_{\tilde{r} \tilde{r} , i}^{- 1} {d}_{B , i , j} \vert}^{2}} .$$

40. The apparatus of claim 36, wherein the SINR is described by the expression
$$\frac{{\sum }_{i = 1}^{N} {d}_{B , i , j}^{H} {R}_{\tilde{r} \tilde{r} , i}^{- 1} {d}_{B , i , j}}{{\sum }_{i = 1}^{N} {\vert {d}_{B , i , j}^{H} {R}_{\tilde{r} \tilde{r} , i}^{- 1} {d}_{B , i , j} \vert}^{2}} .$$
